(19) United States
(12) Patent Application Publication
(10) Pub. No.: US 2023/0209155 A1
(43) Pub. Date: Jun. 29, 2023

(54) CAMERA MODULE

(71) Applicant: SAMSUNG ELECTRO-MECHANICS CO., LTD., Suwon-si (KR)

(72) Inventors: Sung Il JO, Suwon-si (KR); Se Hun KIM, Suwon-si (KR)

(73) Assignee: SAMSUNG ELECTRO-MECHANICS CO., LTD., Suwon-si (KR)

(21) Appl. No.: 17/984,339

(22) Filed: Nov. 10, 2022

(30) Foreign Application Priority Data
Dec. 29, 2021 (KR) 10-2021-0191317

(51) Int. Cl. H04N 5/225; H02K 11/21; H02K 41/035; H04N 5/232

(52) U.S. Cl. CPC H04N 5/2251; H02K 11/21; H02K 41/0356; H04N 5/23238

(57) ABSTRACT

A camera module includes a first lens module and a second lens module, disposed in a first direction intersecting an optical axis; an image sensor configured to convert an optical signal incident through the first lens module and the second lens module into an electrical signal; and a driver configured to move the image sensor in the first direction.

### CROSS-REFERENCE TO RELATED APPLICATION(S)

This application claims the benefit under 35 USC 119(a) of Korean Patent Application No. 10-2021-0191317 filed on Dec. 29, 2021, in the Korean Intellectual Property Office, the entire disclosure of which is incorporated herein by reference for all purposes.

### BACKGROUND

### 1. Field

The following description relates to a camera module.

### 2. Description of Related Art

A camera module may include a lens module for imaging light reflected from an object on an image sensor. In addition, a camera module may include a component for focus adjustment and optical image stabilization. For example, a camera module may include a driver for driving a lens module in an optical axis direction or a direction intersecting an optical axis. Generally, a camera module has one optical property. For example, it may be difficult for a camera module for short-distance imaging to image an object disposed at a long distance, and conversely, it may be difficult for a camera module for long-distance imaging to image an object disposed at a short distance. As another example, it may be difficult for a camera module for short-distance imaging to image at a narrow angle, and it may be difficult for a camera module for long-distance imaging to image at a wide angle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a first lens module and a second lens module, disposed in a first direction intersecting an optical axis; an image sensor configured to convert an optical signal incident through the first lens module and the second lens module into an electrical signal; and a driver configured to move the image sensor in the first direction.

The first lens module may be configured to include a wide-angle optical imaging system. The second lens module may be configured to include a telephoto optical imaging system.

The driver may include a first substrate member coupled to the image sensor and including a driving coil disposed in the first direction; a second substrate member, including a driving magnet disposed in the first direction; and a guide member disposed on the second substrate member and having a groove into which a portion of the first substrate member is insertable.

The camera module may further include a sensing device configured to sense a position of the image sensor.

The sensing device may include a sensing coil and a sensing magnet formed on the first substrate member and the second substrate member, respectively.

The camera module may further include a third lens module disposed in the first direction.

The third lens module may have optical properties different from optical properties of the first lens module and the second lens module.

The camera module may further include a lifter configured to move the image sensor in the optical axis direction.

The lifter may include a pin member configured to push the image sensor in the optical axis direction.

The lifter may include a driving magnet and a driving coil. The driving magnet and the driving coil may be configured to apply attractive force and repulsive force to the image sensor.

The driver may be further configured to selectively move the image sensor in the first direction to align with the first lens module or the second lens module.

The optical signal incident through the first lens module may be different from the optical signal incident through the second lens module.

In another general aspect, a camera module includes a first lens module, a second lens module, and a third lens module, disposed around a virtual axis; a first substrate member, including an image sensor configured to convert an optical signal emitted from the first lens module to the third lens module into an electrical signal, the first substrate member configured to rotate about a fixed shaft; and a driver configured to rotate the first substrate member about the fixed shaft such that an optical axis of the image sensor selectively coincides with an optical axis of the first lens module to the third lens module.

The first lens module to the third lens module may be configured to have different optical properties.

The driver may include a driving magnet and a driving coil formed on the first substrate member and the second substrate member disposed to oppose the first substrate member, respectively.

The camera module may further include a sensing device configured to sense a position of the image sensor.

The camera module may further include a connection terminal configured to connect the first substrate member to the second substrate member.

In another general aspect, a camera module includes a plurality of lens modules; an image sensor configured to convert an optical signal incident through each of the lens modules into an electrical signal, and move in an optical axis direction; and a driver configured to linearly drive the image sensor along a groove in a first direction intersecting the optical axis direction of the image sensor.

The image sensor may be configured to move in the optical axis direction using a driving magnet and a driving coil.

Other features and aspects will be apparent from the following detailed description, the drawings, and the claims.

### BRIEF DESCRIPTION OF DRAWINGS

FIG. 1 is a diagram illustrating a camera module according to an example embodiment of the present disclosure.

FIG. 2 is a diagram illustrating a driver illustrated in FIG. 1.

FIG. 3 is a cross-sectional diagram illustrating a driver illustrated in FIG. 2.

FIG. 4 is a diagram illustrating an operation state of the camera module illustrated in FIG. 1.

FIG. 5 is a diagram illustrating a camera module according to another example embodiment of the present disclosure.

FIG. 6 is a cross-sectional diagram illustrating a driver illustrated in FIG. 5.

FIG. 7 is a cross-sectional diagram illustrating a driver illustrated in FIG. 6.

FIG. 8 is a diagram illustrating an operation state of the camera module illustrated in FIG. 5.

FIG. 9 is a diagram illustrating a lifter according to an example embodiment of the present disclosure.

FIGS. 10A and 10B are diagrams illustrating a lifter according to another example embodiment of the present disclosure.

FIG. 11 is a diagram illustrating a camera module according to another example embodiment of the present disclosure.

FIGS. 12 and 13 are cross-sectional diagrams illustrating the camera module illustrated in FIG. 11.

FIG. 14 is an enlarged diagram illustrating portion A in FIG. 12.

Throughout the drawings and the detailed description, the same reference numerals refer to the same or like elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

It may be desirable to develop a camera module configured to enable various imaging types without replacing a lens module.

A camera module in an example embodiment may be mounted on an electronic device. For example, a camera module may be mounted on a portable terminal, a notebook computer, a VR device, glasses, and the like. However, electronic devices in which a camera module may be mounted are not limited to the aforementioned devices. For example, a camera module may be mounted on portable electronic devices such as a portable game machine.

Also, a camera module in an example embodiment may be mounted on a structure, a transport device, and the like. For example, a camera module may be mounted on a security monitoring device, a front and rear monitoring device of a mobile device, and the like.

The camera module according to the first example embodiment may include a plurality of lens modules. For example, the camera module may include a first lens module and a second lens module disposed in a first direction intersecting the optical axis. However, the number of lens modules included in the camera module is not limited to two. For example, the camera module may include three lens modules (a first lens module, a second lens module, and a third lens module) disposed in order in a first direction intersecting the optical axis.

The lens module may be configured to have different optical properties. For example, the first lens module may be configured as a wide-angle optical imaging system, the second lens module may be configured as a telephoto optical imaging system, and the third lens module may be configured as an optical imaging system having intermediate properties between wide-angle and telephoto. However, the optical imaging system included in the first to third lens modules is not limited to the above-described example.

According to the first example embodiment, the camera module may include an image sensor. The image sensor may be configured to convert an optical signal into an electrical signal. For example, the image sensor may be configured to convert an optical signal incident through the first and second lens modules into electrical signals.

According to the first example, the camera module may include a driver. For example, the camera module may include a driver configured to move the image sensor in a first direction intersecting the optical axis. The driver may be configured to allow the image sensor's optical axis to match the lens module's optical axis. For example, the driver may move the image sensor to one side such that the optical axis of the image sensor may match the optical axis of the first lens module, or the driver may move the image sensor to the other side such that the optical axis of the image sensor may match the optical axis of the second lens module.

According to the second example embodiment, the camera module may include a plurality of lens modules. For example, the camera module may include first to third lens modules disposed around a virtual axis. However, the number of lens modules included in the camera module is not limited to three. For example, the camera module may include four lens modules disposed around a virtual axis.

The lens modules may be formed with an equal distance therebetween around a virtual axis. For example, the first to third lens modules may be disposed in a symmetrical circular shape. However, the first to third lens modules are not necessarily disposed in a symmetrical circular shape. The lens module may be configured to have different optical properties. For example, the first lens module may be configured as a wide-angle optical imaging system, the second lens module may be configured as a telephoto optical imaging system, and the third lens module may be configured as an optical imaging system having intermediate properties between wide-angle and telephoto. However, the optical imaging system included in the first to third lens modules is not limited to the above-described example.

According to the second example embodiment, the camera module may include an image sensor. The image sensor may be configured to convert an optical signal into an electrical signal. For example, the image sensor may be configured to convert an optical signal incident through the first lens module to the third lens module into an electrical signal.

According to the second example embodiment, the camera module may include a component for supporting the image sensor. For example, the camera module, according to the second example embodiment, may include a first substrate member on which an image sensor is mounted or in which an image sensor is embedded. The first substrate member may be configured to be drivable. For example, the first substrate member may rotate in clockwise or counterclockwise directions about a fixed shaft.

According to the second example embodiment, the camera module may include a component for rotating the first substrate member. For example, the camera module may include a driver configured to provide a rotational driving force to the first substrate member. The driver may directly or indirectly provide the driving force desired for the rotational movement of the first substrate member and may enable the rotational movement of the first substrate member. The driver may operate such that the image sensor's optical axis may match the lens module's optical axis. For example, the driver may rotate the first substrate member to a first size such that the optical axis of the image sensor may match the optical axis of the first lens module. As another example, the driver may rotate the first substrate member to a second size such that the optical axis of the image sensor may match the optical axis of the second lens module. As another example, the driver may rotate the first substrate member to a third size such that the optical axis of the image sensor may match the optical axis of the third lens module.

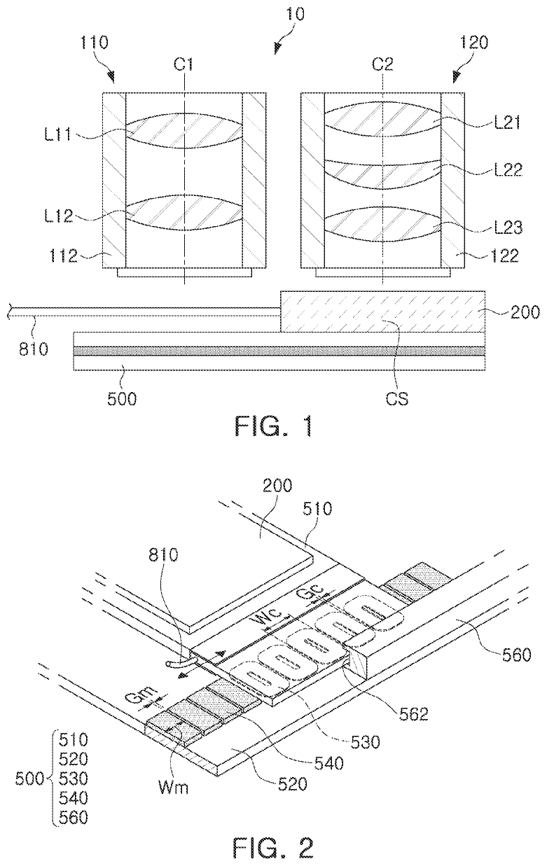

Hereinafter, a camera module, according to an example embodiment, will be described with reference to the drawings. First, a camera module, according to an example embodiment, will be described with reference to FIGS. 1 to 4.

The camera module 10, according to the example embodiment, may include a first lens module 110, a second lens module 120, an image sensor 200, and a driver 500. However, the components of the camera module 10 is not limited to the above-described members. For example, the camera module 10 may further include a connector 810 for electrically connecting the image sensor 200 to a main board (not illustrated).

The first lens module 110 may include lenses L11 and L12 and a lens barrel 112. However, the components of the first lens module 110 is not limited to the above-described members. For example, the first lens module 110 may further include a space-maintaining member for maintaining a constant distance between the lenses L11 and L12, and a stop for controlling the amount of light incident to the first lens L11 or selectively blocking light incident to the first lens L11.

The first lens module 110 may include a plurality of lenses L11 and L12. For example, the first lens module 110 may include two lenses L11 and L12 disposed in order along the first optical axis C1. However, the number of lenses included in the first lens module 110 is not limited to two. Each of the lenses L11 and L12 may have predetermined refractive power. For example, each of the first lens L11 and the second lens L12 may have positive refractive power. However, the refractive power of the first lens L11 and the second lens L12 is not limited to positive refractive power. The first lens module 110 may be configured to have predetermined optical properties. For example, the first lens module 110 may include an optical imaging system with a field of view of less than 30 degrees or that can perform long-distance imaging.

The second lens module 120 may include lenses L21, L22, and L23 and a lens barrel 122. However, the components of the second lens module 120 is not limited to the above-described members. For example, the second lens module 120 may further include a space-maintaining member for maintaining a constant distance between the lenses L21, L22, and L23, and a stop for controlling the amount of light incident to the first lens L21 or selectively blocking light incident to the first lens L21.

The second lens module 120 may include a plurality of lenses L21, L22, and L23. For example, the second lens module 120 may include three lenses L21, L22, and L23 disposed in order along the second optical axis C2. However, the number of lenses included in the second lens module 120 is not limited to three. Each of the lenses L21, L22, and L23 may have predetermined refractive power. For example, the first lens L21 and the third lens L23 may have a positive refractive power, and the second lens L22 may have negative refractive power. However, refractive power of the first lens L21 to the third lens L23 is not limited to the above-described example. The second lens module 120 may be configured to have predetermined optical properties. For example, the second lens module 120 may be configured to have optical properties different from the optical properties of the first lens module 110. As a specific example, the second lens module 120 may include an optical imaging system having a field of view of 40 degrees or more or able to perform short-distance imaging.

The image sensor 200 may be configured to convert an optical signal into an electrical signal. For example, the image sensor 200 may convert an optical signal obtained through the first lens module 110 and the second lens module 120 into an electrical signal. The image sensor 200 may be manufactured in the form of CMOS, CCD, or the like.

The image sensor 200 may have a predetermined size. For example, the image sensor 200 may have a size in which the image sensor 200 may convert only an optical signal obtained through one of the first lens module 110 and the second lens module 120 into an electrical signal. More specifically, when the image sensor 200 is disposed such that the optical axis CS of the image sensor 200 and the first optical axis C1 of the first lens module 110 coincide with each other, light incident through the second lens module 120 may not reach the image sensor 200. Conversely, when the image sensor 200 is disposed such that the optical axis CS of the image sensor 200 and the second optical axis C2 of the second lens module 120 coincide with each other, light incident through the first lens module 110 may not reach the image sensor 200. Accordingly, in the camera module 10, according to the example embodiment, flares that may be caused as light incident through the first lens module 110 and the second lens module 120 are simultaneously provided to the image sensor 200 may be alleviated or blocked.

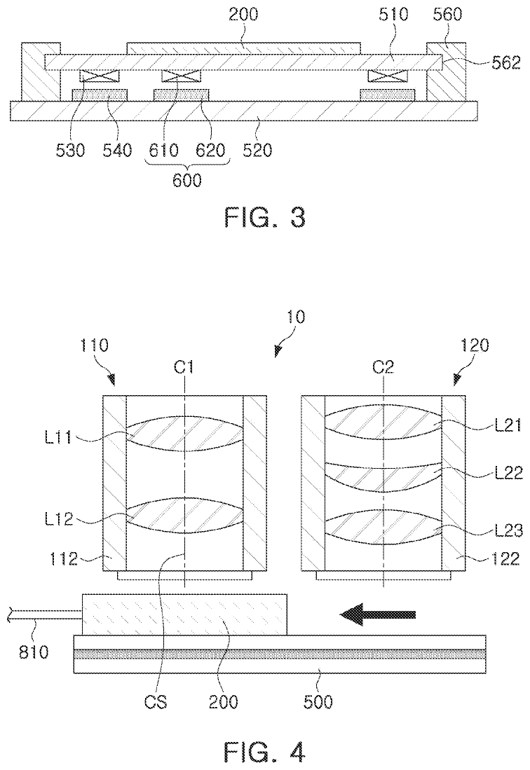

The driver 500 may be configured to drive the image sensor 200. For example, the driver 500 may move the image sensor 200 in a first direction intersecting the optical axis CS of the image sensor 200. In the description below, the structure of the driver 500 will be described in greater detail with reference to FIGS. 2 and 3.

The driver 500 may include a first substrate member 510, a second substrate member 520, a driving coil 530, a driving magnet 540, and a guide member 560. However, the components of the driver 500 is not limited to the above-described members. For example, the driver 500 may further include a component for reducing contact friction between the first substrate member 510 and the guide member 560. In a non-limiting example, the driver 500 may further include a ball bearing and a roll bearing disposed between the first substrate member 510 and the guide member 560.

The first substrate member 510 may be configured such that the image sensor 200 may be mounted thereon. For example, a space in which the image sensor 200 may be mounted may be formed on one surface of the first substrate member 510. The first substrate member 510 may be electrically connected to the image sensor 200. For example, the first substrate member 510 may be electrically connected to the image sensor 200 through a printed circuit formed therein or on the surface. The first substrate member 510 may include a driving coil 530. For example, a driving coil 530 may be formed on one surface (a lower surface in FIG. 2) of the first substrate member 510.

The driving coils 530 may be formed with a predetermined distance therebetween in one direction of the first substrate member 510. For example, the driving coils 530 may be formed on the lower surface of the first substrate member 510 with an equal distance therebetween in the moving direction (the first direction) of the image sensor 200. As a specific example, the plurality of driving coils 530 may be formed linearly with a first distance Gc. However, the positions in which driving coils 530 are formed and the distance between the driving coils 530 are not limited to the examples illustrated in FIG. 2. The driving coil 530 may be configured to enable continuous movement of the first substrate member 510. For example, the first distance Gc may be smaller than a length Wc of the driving coil 530 in the first direction. However, the first gap Gc is not necessarily smaller than the length Wc. For example, the first distance Gc may change within a range in which interaction between the driving coil 530 and the driving magnet 540 may be possible.

The driving coil 530 may be electrically connected to a main circuit or main board of the camera module 10. For example, the driving coil 530 may be electrically connected to a main circuit or main board of the camera module 10 through the printed circuit of the first substrate member 510 and the connection member 810. The connection member 810 illustrated in FIG. 2 may be modified to an FPCB form.

The second substrate member 520 may be disposed to oppose the first substrate member 510. For example, the second substrate member 520 may be disposed to oppose the lower surface of the first substrate member 510. The second substrate member 520 may include a driving magnet 540. For example, the driving magnet 540 may be formed on one surface (the upper surface in FIG. 2) of the second substrate member 520.

The driving magnets 540 may be formed with a predetermined distance therebetween in one direction of the second substrate member 520. For example, the driving magnets 540 may be formed on the upper surface of the second substrate member 520 with an equal distance in the moving direction (first direction) of the image sensor 200. As a specific example, the plurality of driving magnets 540 may be formed linearly with a second distance Gm therebetween. However, the positions in which the driving magnets 540 are formed and the distance between the driving magnets 540 are not limited to the examples illustrated in FIG. 2. The driving magnet 540 may be configured to enable continuous movement of the first substrate member 510. For example, the second distance Gm may be smaller than the length Wm of the driving magnet 540 in the first direction. However, the second gap Gm is not necessarily smaller than the length Wm. For example, the second distance Gm may change within a range where interaction between the driving coil 530 and the driving magnet 540 may be possible. As a specific example, the second gap Gm may be formed to have a size larger than the length Wm of the driving magnet 540 within a range in which interaction between the driving coil 530 and the driving magnet 540 may be possible.

The guide member 560 may be configured to support the first substrate member 510. More specifically, the guide member 560 may be coupled to the first substrate member 510 and may maintain the position of the first substrate member 510 to be constant. For example, the guide member 560 may be coupled to the edge of the first substrate member 510 and may maintain a level of the first substrate member 510 to be constant. As another example, the guide member 560 may be coupled to both edges of the first substrate member 510 and may prevent the first substrate member 510 from swinging in a direction intersecting the moving direction of the image sensor 200. The guide member 560 may include a component for coupling to the first substrate member 510. For example, a groove 562 into which the first substrate member 510 is inserted may be formed in one side surface of the guide member 560. The groove 562 may be formed to have substantially the same size as the thickness of the first substrate member 510, and may be formed to be elongated in the moving direction of the image sensor 200.

The driver 500 configured as above may provide driving force desired for the movement of the image sensor 200 through interaction between the driving coil 530 and the driving magnet 540, as illustrated in FIGS. 2 and 3. Accordingly, the image sensor 200 may be selectively disposed to convert the optical signal incident from the first lens module 110 into an electrical signal by the driving force of the driver 500 or may be selectively disposed to convert an optical signal incident from the second lens module 120 into an electrical signal by the driving force, as illustrated in FIG. 4. In an example, the driver 500 may be configured to drive the image sensor 200 into alignment with the first lens module 110 or the second lens module 120 to respectively convert an optical signal from the first lens module 110 or another optical signal from the second lens module 120 into electrical signal.

The camera module 10, according to the example embodiment, may further include a component for allowing the optical axis CS of the image sensor 200 to match the optical axes C1 and C2 of the lens modules 110 and 120. For example, the camera module 10 may further include a sensing device 600. The sensing device 600 may include a sensing coil 610 and a sensing magnet 620. The sensing coil 610 may be disposed on the first substrate member 510, and the sensing magnet 620 may be disposed on the second substrate member 520. However, the arrangement positions of the sensing coil 610 and the sensing magnet 620 are not limited to the above-described example. For example, the sensing coil 610 may be disposed on the second substrate member 520, and the sensing magnet 620 may be disposed on the first substrate member 510. The sensing magnet 620 may be disposed in a position corresponding to the first optical axis C1 of the first lens module 110 and the second optical axis C2 of the second lens module 120. As an example, the plurality of sensing magnets 620 may be disposed with a predetermined distance about the first optical axis C1 and the second optical axis C2.

The sensing device 600 configured as above may sense the position of the image sensor 200 through interaction between the sensing coil 610 and the sensing magnet 620 generated at a point at which the first optical axis C1 or the second optical axis C2 is disposed. Accordingly, in the camera module 10, according to the example embodiment, the movement displacement of the image sensor 200 may be determined such that the optical axis CS of the image sensor 200 may match the first optical axis C1 or the second optical axis C2 through position information of the image sensor 200 obtained by the sensing device 600.

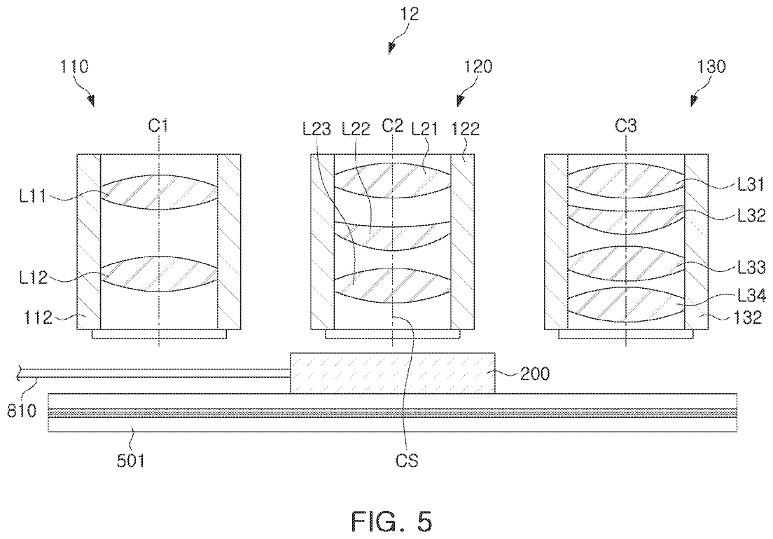

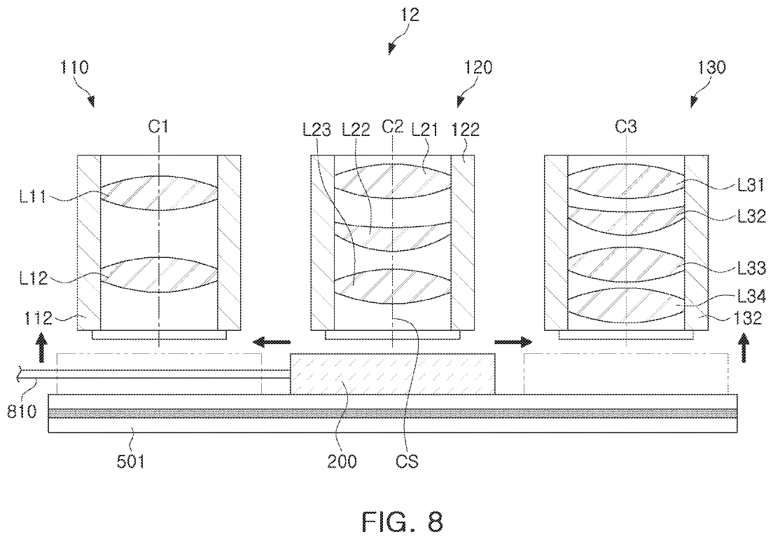

In the description below, a camera module, according to another example embodiment, will be described with reference to FIGS. 5 to 10B.

The camera module 12, according to the example embodiment, may include a first lens module 110, a second lens module 120, a third lens module 130, an image sensor 200, and a driver 501. However, the components of the camera module 12 are not limited to the above-described members. For example, the camera module 12 may further include a connector 810 for electrically connecting the image sensor 200 to a main board (not illustrated).

The first lens module 110 may include lenses L11 and L12 and a lens barrel 112. However, the components of the first lens module 110 are not limited to the above-described members. For example, the first lens module 110 may include a space-maintaining member for maintaining a constant distance between the lenses L11 and L12, and a stop for controlling the amount of light incident to the first lens L11 or selectively blocking light incident to the first lens L11.

The first lens module 110 may include a plurality of lenses L11 and L12. For example, the first lens module 110 may include two lenses L11 and L12 disposed in order along the first optical axis C1. However, the number of lenses included in the first lens module 110 is not limited to two. Each of the lenses L11 and L12 may have predetermined refractive power. For example, each of the first lens L11 and the second lens L12 may have positive refractive power. However, refractive power of the first lens L11 and the second lens L12 is not limited to positive refractive power. The first lens module 110 may be configured to have predetermined optical properties. For example, the first lens module 110 may include an optical imaging system with a field of view of less than 30 degrees or that can perform long-distance imaging.

The second lens module 120 may include lenses L21, L22, and L23 and a lens barrel 122. However, the components of the second lens module 120 is not limited to the above-described members. For example, the second lens module 120 may further include a space-maintaining member for maintaining a constant distance between the lenses L21, L22, and L23, and a stop for controlling the amount of light incident to the first lens L21 or selectively blocking light incident to the first lens L21.

The second lens module 120 may include a plurality of lenses L21, L22, and L23. For example, the second lens module 120 may include three lenses L21, L22, and L23 disposed in order along the second optical axis C2. However, the number of lenses included in the second lens module 120 is not limited to three. Each of the lenses L21, L22, and L23 may have predetermined refractive power. For example, each of the first lens L21 and the third lens L23 may have positive refractive power, and the second lens L22 may have negative refractive power. However, the refractive power of the first lens L21 to the third lens L23 is not limited to the above-described examples. The second lens module 120 may be configured to have predetermined optical properties. For example, the second lens module 120 may be configured to have optical properties different from the optical properties of the first lens module 110. As a specific example, the second lens module 120 may include an optical imaging system having a field of view in a range of 40 to 80 degrees or able to perform short-distance imaging

The second lens module 120 may include lenses L21, L22, and L23 and a lens barrel 122. However, the components of the second lens module 120 are not limited to the above-described members. For example, the second lens module 120 may further include a space-maintaining member for maintaining a constant distance between the lenses L21, L22, and L23, and a stop for controlling the amount of light incident to the first lens L21 or selectively blocking light incident to the first lens L21.

The third lens module 130 may include a plurality of lenses L31, L32, L33, and L34. For example, the third lens module 130 may include four lenses L31, L32, L33, and L34 disposed in order along the third optical axis C3. However, the number of lenses included in the third lens module 130 is not limited to four. Each of the lenses L31, L32, L33, and L34 may have predetermined refractive power. For example, each of the first lens L31, the third lens L33, and the fourth lens L34 may have positive refractive power, and the second lens L32 may have negative refractive power. However, the refractive power of the first lens L31 to the fourth lens L34 is not limited to the above-described example. The third lens module 130 may be configured to have predetermined optical properties. For example, the third lens module 130 may be configured to have optical properties different from those of the first lens module 110 and the second lens module 120. As a specific example, the third lens module 130 may include an optical imaging system having a field of view of 90 degrees or more or able to image with high resolution.

The third lens module 130 may include lenses L31, L32, L33, and L34 and a lens barrel 132. However, the components of the third lens module 130 is not limited to the above-described members. For example, the third lens module 130 may further include a space-maintaining member for maintaining a constant distance between the lenses L31, L32, L33, and L34, and a stop for controlling the amount of light incident to the first lens L31 or selectively blocking light incident to the first lens L31.

The image sensor 200 may be configured to convert an optical signal into an electrical signal. For example, the image sensor 200 may convert an optical signal obtained through the first lens module 110 to the third lens module 130 into an electrical signal. The image sensor 200 may be manufactured in the form of CMOS, CCD, or the like.

The image sensor 200 may have a predetermined size. For example, the image sensor 200 may have a size in which the image sensor 200 may convert only an optical signal obtained through one of the first lens module 110 to the third lens module 130 into an electrical signal. For example, when the image sensor 200 is disposed such that the optical axis CS of the image sensor 200 coincides with the first optical axis C1 of the first lens module 110, light incident through the second lens module 120 and the third lens module 130 may not reach the image sensor 200. As another example, when the image sensor 200 is disposed such that the optical axis CS of the image sensor 200 coincides with the second optical axis C2 of the second lens module 120, light incident through the first lens module 110 and the third lens module 130 may not reach the image sensor 200. As another example, when the image sensor 200 is disposed such that the optical axis CS of the image sensor 200 coincides with the third optical axis C3 of the third lens module 130, light incident through the first lens module 110 and the second lens module 120 may not reach the image sensor 200.

Therefore, in the camera module 12, according to the example embodiment, flares that may be caused by light incident through the first lens module 110 to the third lens module 130 are simultaneously provided to the image sensor 200 and may be alleviated or blocked.

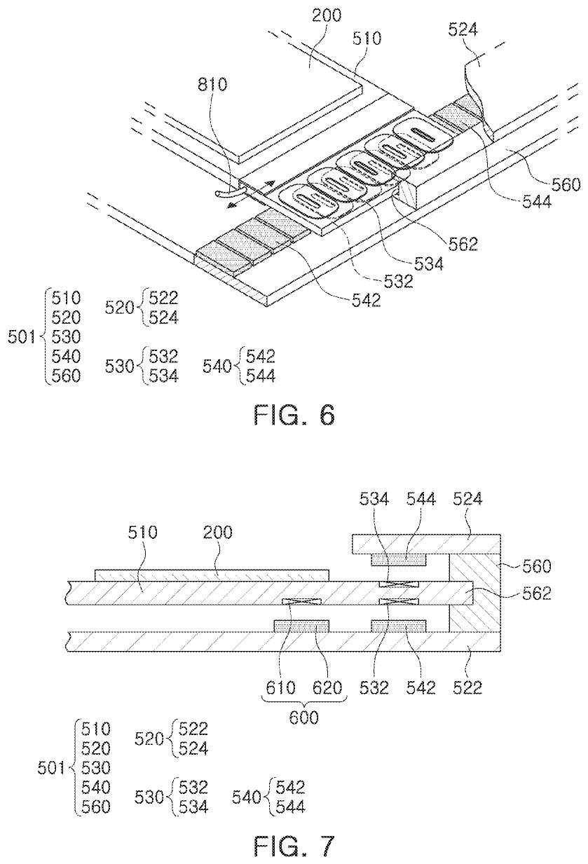

The driver 501 may be configured to drive the image sensor 200. For example, the driver 501 may move the image sensor 200 in a first direction intersecting the optical axis CS of the image sensor 200. In the description below, the structure of the driver 501 will be described in greater detail with reference to FIGS. 6 and 7.

The driver 501 may include a first substrate member 510, a second substrate member 522, 524, a driving coil 530, a driving magnet 540, and a guide member 560. However, the components of the driver 501 is not limited to the above-described members. For example, the driver 501 may further include a component for reducing contact friction between the first substrate member 510 and the guide member 560. As a specific example, the driver 501 may further include a ball bearing and a roll bearing disposed between the first substrate member 510 and the guide member 560.

The first substrate member 510 may be configured such that the image sensor 200 may be mounted thereon. For example, a space in which the image sensor 200 may be mounted may be formed on one surface of the first substrate member 510. The first substrate member 510 may be electrically connected to the image sensor 200. For example, the first substrate member 510 may be electrically connected to the image sensor 200 through a printed circuit formed therein or on the surface. The first substrate member 510 may include driving coils 530 (532 and 534). For example, a first driving coil 532 and a second driving coil 534 may be formed on the upper and lower surfaces of the first substrate member 510, respectively.

The first driving coil 532 and the second driving coil 534 may be formed with a predetermined distance therebetween in one direction of the first substrate member 510. For example, the first driving coil 532 and the second driving coil 534 may be respectively formed on the upper and lower surfaces of the first substrate member 510 with a predetermined distance therebetween the moving direction (the first direction) of the image sensor 200. The first driving coil 532 and the second driving coil 534 may be configured to enable continuous movement of the first substrate member 510. For example, the first driving coil 532 and the second driving coil 534 may be alternately formed as illustrated in FIG. 6. However, the arrangement of the first driving coil 532 and the second driving coil 534 is not limited to the examples illustrated in FIG. 6. For example, the first driving coil 532 and the second driving coil 534 may be formed with a different distance therebetween, or the first driving coil 532 and the second driving coil 534 may be formed to be vertically symmetrical to each other. The first driving coil 532 and the second driving coil 534 may be integrated with the first substrate member 510. For example, the first driving coil 532 and the second driving coil 534 may be formed in the form of a printed circuit integrated with the first substrate member 510.

The first driving coil 532 and the second driving coil 534 may be electrically connected to a main circuit or main board of the camera module 12. For example, the first driving coil 532 and the second driving coil 534 may be electrically connected to a main circuit or main board of the camera module 12 through a printed circuit and the connection member 810 of the first substrate member 510. The connection member 810 according to FIG. 6 is illustrated in the form of a conducting wire, but the connection member 810 may modified to an FPCB or other form.

A plurality of the second substrate members 520 may be provided. For example, the second substrate member 520 may include a second substrate 522 disposed below the first substrate member 510 and a second substrate 524 disposed above the first substrate member 510. However, the number of substrates included in the second substrate member 520 is not limited to two. For example, the second substrate member 520 may be configured as a single substrate as in the above-described example embodiment.

The second substrate 522 and the second substrate 524 may be disposed to oppose the first substrate member 510. For example, the second substrate 522 may be disposed to oppose the lower surface of the first substrate member 510, and the second substrate 524 may be disposed to oppose the upper surface of the first substrate member 510. The second substrate 522 and the second substrate 524 may include a driving magnet 540. For example, a first driving magnet 542 may be formed on one surface (the upper surface in FIG. 6) of the second substrate 522, and a second driving magnet 544 may be formed on one surface (the lower surface in FIG. 6) of the second substrate 524.

The first driving magnet 542 and the second driving magnet 544 may be formed with a predetermined distance in one direction of the second substrates 522 and 524. For example, the first driving magnet 542 and the second driving magnet 544 may be formed on the upper surface of the second substrate 522 and the lower surface of the second substrate 524 with a predetermined distance in the first direction. The first driving magnet 542 and the second driving magnet 544 may be configured to enable continuous movement of the first substrate member 510. For example, the first driving magnet 542 and the second driving magnet 544 may be formed with the same distance as the distance between the first driving coil 532 and the second driving coil 534 as illustrated in FIG. 6. However, the arrangement of the first driving magnet 542 and the second driving magnet 544 is not limited to the example illustrated in FIG. 6.

The guide member 560 may be configured to support the first substrate member 510. More specifically, the guide member 560 may be coupled to the first substrate member 510 and may maintain the position of the first substrate member 510 to be constant. For example, the guide member 560 may be coupled to the edge of the first substrate member 510 and may maintain a level of the first substrate member 510 to be constant. As another example, the guide member 560 may be coupled to both edges of the first substrate member 510 and may prevent the first substrate member 510 from swinging in a direction intersecting the moving direction of the image sensor 200. The guide member 560 may include a component for coupling to the first substrate member 510. For example, a groove 562 into which the first substrate member 510 is inserted may be formed in one side surface of the guide member 560. The groove 562 may be formed to have substantially the same size as the thickness of the first substrate member 510, and may be formed to be elongated in the moving direction of the image sensor 200.

The driver 501 configured as above may provide the driving force desired for the movement of the image sensor 200 through the interaction between the driving coil 530 and the driving magnet 540, as illustrated in FIG. 7. Accordingly, the image sensor 200 may be disposed to convert an optical signal incident from the first lens module 110 to the third lens module 130 into an electrical signal by driving force of the driver 501.

The camera module 12, according to the example embodiment, may further include a component for allowing the optical axis CS of the image sensor 200 to match the optical axes C1, C2, and C3 of the lens modules 110, 120, and 130. For example, the camera module 12 may further include a sensing device 600. The sensing device 600 may include a sensing coil 610 and a sensing magnet 620. The sensing coil 610 may be disposed on the first substrate member 510, and the sensing magnet 620 may be disposed on the second substrate 522. However, the arrangement position of the sensing coil 610 and the sensing magnet 620 is not limited to the above-described example. For example, the sensing coil 610 may be disposed on the second substrate 522, and the sensing magnet 620 may be disposed on the first substrate member 510. The sensing magnet 620 may be disposed in positions corresponding to the optical axes C1, C2, and C3 of the first lens module 110 to the third lens module 130. For example, the plurality of sensing magnets 620 may be disposed at points coincident with the first optical axis C1 to the third optical axis C3. As another example, the plurality of sensing magnets 620 may be disposed with predetermined distances in the first direction. As a specific example, the plurality of sensing magnets 620 may be densely disposed at points coincident with the first optical axis C1 to the third optical axis C3, and may be disposed at the other points with a predetermined distance.

The sensing device 600 configured as above may sense a position of the image sensor 200 through interaction between the sensing coil 610 and the sensing magnet 620. Accordingly, in the camera module 12, according to the example embodiment, the movement displacement of the image sensor 200 may be determined such that the optical axis CS of the image sensor 200 may match the first optical axis C1 to the third optical axis C3 through position information of the image sensor 200 obtained by the sensing device 600.

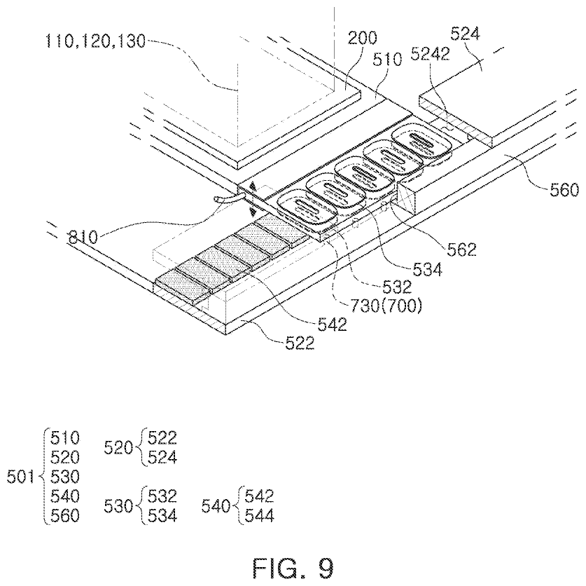

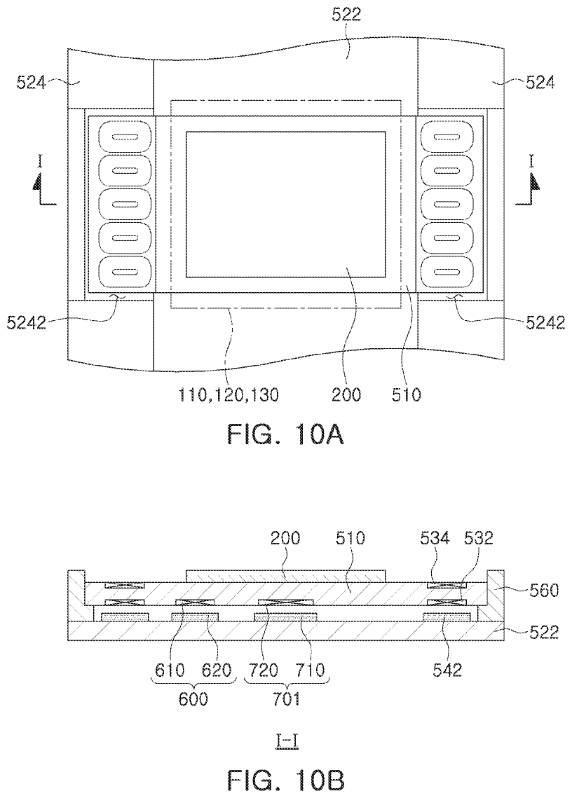

The camera module 12, according to the example embodiment, may further include a means for adjusting the distance between the lens modules 110, 120, and 130 and the image sensor 200 in the optical axis direction. For example, the camera module 12 may further include lifter 700 and 701 as illustrated in FIGS. 9, 10A and 10B.

The lifter 700 and 701 may include an entirety of forms configured to push up or pull the first substrate member 510 in the optical axis direction. For example, the lifter 700 and 701 may be configured in the form of a pin member 730 disposed on the second substrate 522 as illustrated in FIG. 9, or may be configured in the form of a driving magnet 710 and a driving coil 720 disposed on the first substrate member 510 and the second substrate 522 as illustrated in FIGS. 10A and 10B. However, the shape of the lifter 700 and 701 is not limited to the pin member 730, the driving magnet 710 and the driving coil 720 illustrated in FIGS. 9, 10A and 10B. For example, the lifter 700 and 701 may be modified to a form using hydraulic pressure or pneumatic pressure.

The lifter 700 according to an example embodiment will be described with reference to FIG. 9.

The lifter 700 may be configured to move the first substrate member 510 toward the lens module 110, 120, and 130. For example, the pin member 730 of the lifter 700 may protrude from the second substrate 522 and may push up the first substrate member 510 upward. The vertical movement of the first substrate member 510 by the lifter 700 may be performed only at a predetermined point. For example, the vertical movement of the first substrate member 510 may be performed at points (hereinafter, referred to as lifting allowed points) at which the optical axis CS of the image sensor 200 matches the optical axes C1, C2, and C3 of the lens modules 110, 120, and 130. Also, the lifter 700 may be formed only in the lifting allowed point. Also, as illustrated in FIG. 9, a partial region 5242 of the second substrate 524 may be cut or opened such that the first substrate member 510 may move up and down.

A lifter 701 according to another example embodiment will be described with reference to FIGS. 10A and 10B.

The lifter 701 may be configured to move the first substrate member 510 toward the lens module 110, 120, and 130, similarly to the above-described example. For example, the lifter 701 may push up the first substrate member 510 upwardly through magnetic force created between the driving magnet 710 and the driving coil 720. The vertical movement of the first substrate member 510 by the lifter 701 may be performed only at a predetermined point. For example, the vertical movement of the first substrate member 510 may be performed at points (hereinafter, referred to as lifting allowed points) at which the optical axis CS of the image sensor 200 matches the optical axes C1, C2, and C3 of the lens modules 110, 120, and 130. Also, the lifter 701 may be formed only in the above-described lifting allowed point. More specifically, the driving magnet 710 may be formed only in a region corresponding to the lifting allowed point on the second substrate 522. Also, as illustrated in FIGS. 10A and 10B, a partial region 5242 of the second substrate 524 may be cut or opened such that the first substrate member 510 may move up and down. The driving coil 720 may be formed on the first substrate member 510 and the driving magnet 710 may be disposed on the second substrate 522, but the positions of the driving magnet 710 and the driving coil 720 may change if desired.

The camera module 12, including the lifter 700 and 701 configured as above, may adjust a focal length by adjusting the distance between the image sensor 200 and the lens module 110, 120, and 130. As another example, the camera module 12 may closely attach the image sensor 200 to the lens module 110, 120, and 130, such that a foreign object or reflected light passing through the space between the image sensor 200 and the lens module 110, 120, and 130 may be reduced or prevented.

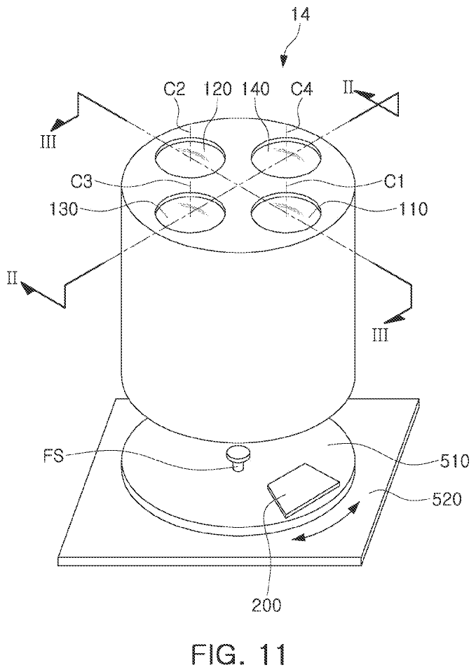

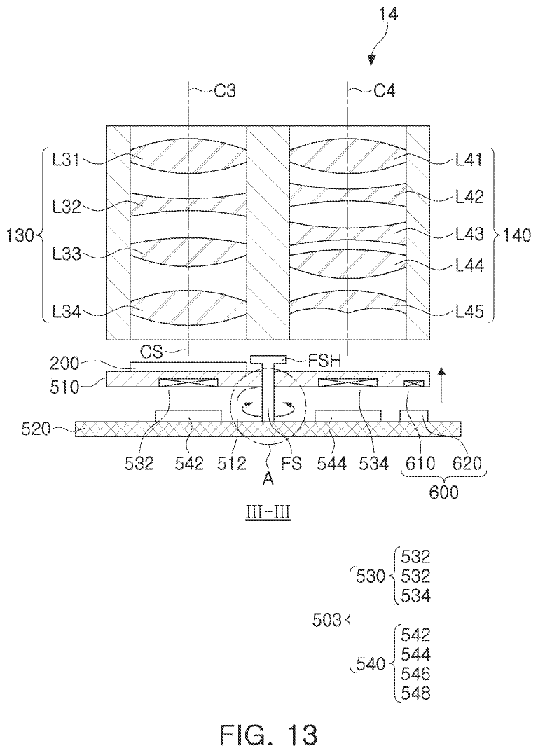

In the description below, a camera module, according to another example embodiment, will be described with reference to FIGS. 11 to 14.

The camera module 14, according to the example embodiment, may include a first lens module 110, a second lens module 120, a third lens module 130, a fourth lens module 140, an image sensor 200, a first substrate member 510, a second substrate member 520, and a driver 503. However, the components of the camera module 14 is not limited to the above-described members.

The first lens module 110 may include lenses L11 and L12 and a lens barrel 112. However, the components of the first lens module 110 is not limited to the above-described members. For example, the first lens module 110 may further include a space-maintaining member for maintaining a constant distance between the lenses L11 and L12, and a stop for controlling the amount of light incident to the first lens L11 or selectively blocking light incident to the first lens L11.

The first lens module 110 may include a plurality of lenses L11 and L12. For example, the first lens module 110 may include two lenses L11 and L12 disposed in order along the first optical axis C1. However, the number of lenses included in the first lens module 110 is not limited to two. Each of the lenses L11 and L12 may have predetermined refractive power. For example, each of the first lens L11 and the second lens L12 may have positive refractive power. However, the refractive power of the first lens L11 and the second lens L12 is not limited to positive refractive power. The first lens module 110 may be configured to have predetermined optical properties. For example, the first lens module 110 may include an optical imaging system with a field of view of less than 30 degrees or that can perform long-distance imaging.

The second lens module 120 may include a plurality of lenses L21, L22, and L23. For example, the second lens module 120 may include three lenses L21, L22, and L23 disposed in order along the second optical axis C2. However, the number of lenses included in the second lens module 120 is not limited to three. Each of the lenses L21, L22, and L23 may have predetermined refractive power. For example, each of the first lens L21 and the third lens L23 may have positive refractive power, and the second lens L22 may have negative refractive power. However, the refractive power of the first lens L21 to the third lens L23 is not limited to the above-described example. The second lens module 120 may be configured to have predetermined optical properties. For example, the second lens module 120 may be configured to have optical properties different from that of the first lens module 110. As a specific example, the second lens module 120 may include an optical imaging system with a field of view in a range of 40 to 80 degrees or that can perform short-distance imaging.

The third lens module 130 may include a plurality of lenses L31, L32, L33, and L34. For example, the third lens module 130 may include four lenses L31, L32, L33, and L34 disposed in order along the third optical axis C3. However, the number of lenses included in the third lens module 130 is not limited to four. Each of the lenses L31, L32, L33, and L34 may have predetermined refractive power. For example, each of the first lens L31, the third lens L33, and the fourth lens L34 may have positive refractive power, and the second lens L32 may have negative refractive power. However, the refractive power of the first lens L31 to the fourth lens L34 is not limited to the above-described example. The third lens module 130 may be configured to have predetermined optical properties. For example, the third lens module 130 may be configured to have optical properties from different those of the first lens module 110 and the second lens module 120. As a specific example, the third lens module 130 may include an optical imaging system having a field of view of 90 degrees or more or able to image with high resolution.

The fourth lens module 140 may include a plurality of lenses L41, L42, L43, L44, and L45. For example, the fourth lens module 140 may include five lenses L41, L42, L43, L44, and L45 disposed in order along the fourth optical axis C4. However, the number of lenses included in the fourth lens module 140 is not limited to five. Each of the lenses L41, L42, L43, L44, and L45 may have predetermined refractive power. For example, each of the first lens L41 and the fourth lens L44 may have positive refractive power, and the second lens L42, the third lens L43, and the fifth lens L45 may have a negative refractive power. However, the refractive power of the first lens L41 to the fifth lens L45 is not limited to the above-described example. The fourth lens module 140 may be configured to have predetermined optical properties. For example, the fourth lens module 140 may be configured to have optical properties different from those of the first lens module 110 to the third lens module 130. As a specific example, the fourth lens module 140 may be configured as an optical imaging system having a resolution higher than that of the first lens module 110 to the third lens module 130.

The first lens module 110 to the fourth lens module 140 may be disposed around a virtual axis. For example, the first lens module 110 to the fourth lens module 140 may be disposed in a symmetrical circular shape about the fixed shaft FS. As another example, the optical axes C1, C2, C3, and C4 of the first lens module 110 to the fourth lens module 140 may be disposed in a symmetrical circular shape about the fixed shaft FS.

The image sensor 200 may be configured to convert an optical signal into an electrical signal. For example, the image sensor 200 may convert an optical signal obtained through the first lens module 110 to the fourth lens module 140 into an electrical signal. The image sensor 200 may be manufactured in the form of CMOS, CCD, or the like.

The image sensor 200 may have a predetermined size. For example, the image sensor 200 may have a size in which the image sensor 200 may convert only an optical signal obtained through one of the first lens module 110 and the second lens module 120 into an electrical signal. For example, when the image sensor 200 is disposed such that the optical axis CS of the image sensor 200 coincides with the first optical axis C1 of the first lens module 110, light incident through the second lens module 120 and the third lens module 130 may not reach the image sensor 200. As another example, when the image sensor 200 is disposed such that the optical axis CS of the image sensor 200 coincides with the second optical axis C2 of the second lens module 120, light incident through the first lens module 110 and the third lens module 130 may not reach the image sensor 200. As another example, when the image sensor 200 is disposed such that the optical axis CS of the image sensor 200 coincides with the third optical axis C3 of the third lens module 130, light incident through the first lens module 110 and the second lens module 120 may not reach the image sensor 200. As another example, when the image sensor 200 is disposed such that the optical axis CS of the image sensor 200 coincides with the fourth optical axis C4 of the fourth lens module 140, light incident through the first lens module 110 to the third lens module 130 may not reach the image sensor 200.

Therefore, in the camera module 14, according to the example embodiment, flares that may be caused by light incident through the first lens module 110 to the fourth lens module 140 are simultaneously provided to the image sensor 200 and may be alleviated or blocked.

The first substrate member 510 may be configured such that the image sensor 200 may be mounted. For example, a space in which the image sensor 200 may be mounted may be formed in one surface of the first substrate member 510. The first substrate member 510 may be electrically connected to the image sensor 200. For example, the first substrate member 510 may be electrically connected to the image sensor 200 through a printed circuit formed therein or on the surface. The first substrate member 510 may be formed in a disk shape. However, the shape of the first substrate member 510 is not limited to a disk shape. The first substrate member 510 may be configured to rotate. For example, the first substrate member 510 may rotate about the fixed shaft FS. A hole 512 to which the fixed shaft FS is inserted may be formed in the first substrate member 510.

The second substrate member 520 may be disposed to oppose the first substrate member 510. For example, the second substrate member 520 may be disposed to oppose the lower surface of the first substrate member 510. The second substrate member 520 may be configured to support the first substrate member 510. For example, a fixed shaft FS working as a rotation center of the first substrate member 510 may be coupled to the second substrate member 520. The fixed shaft FS may include a component preventing the separation of the first substrate member 510. For example, a head portion FSH having a diameter larger than that of the hole 512 of the first substrate member 510 may be formed on an upper end of the fixed shaft FS.

The driver 503 may include a driving coil 530 and a driving magnet 540. A plurality of the driving coil 530 and a plurality of the driving magnet 540 may be provided. For example, the driving coil 530 may include four coils 532, 534, 536, and 538, and the driving magnet 540 may include four magnets 542, 544, 546, and 548. The coils 532, 534, 536, and 538 and the magnets 542, 544, 546, and 548 may be circularly disposed about the fixed shaft FS. However, the number of coils 532, 534, 536, 538 and the number of magnets 542, 544, 546, 548 is not limited to four. For example, the driving coil 530 and the driving magnet 540 may include three or fewer coils and three or fewer magnets, respectively, or may include five or more coils and five or more magnets, respectively. The coils 532, 534, 536, 538 and magnets 542, 544, 546, 548 may be disposed with an equal distance therebetween. For example, the coils 532, 534, 536, and 538 and the magnets 542, 544, 546, and 548 may be disposed with an equal distance therebetween about the fixed shaft FS. However, the coils 532, 534, 536, and 538 and the magnets 542, 544, 546, 548 are not necessarily disposed with an equal distance therebetween. For example, the driving coil 530 and the driving magnet 540 may be disposed in an asymmetrical form within a range in which rotational driving of the first substrate member 510 may be swiftly performed.

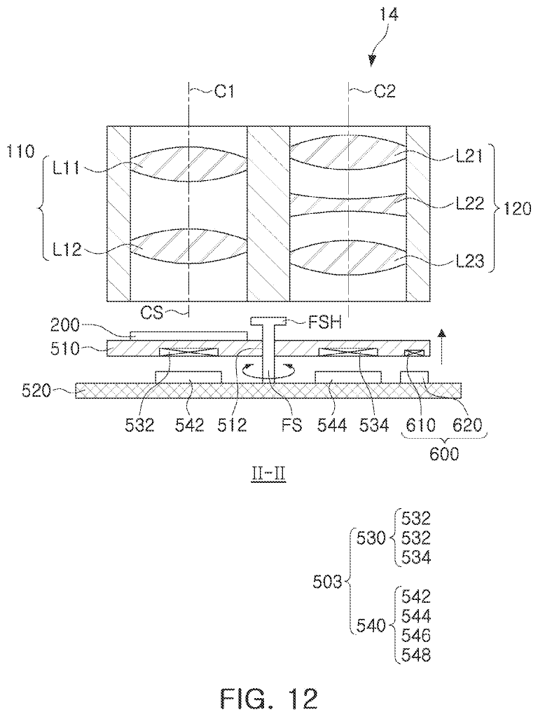

The driver 503 configured as described above may be configured to rotate the first substrate member 510. For example, the driver 503 may rotate the first substrate member 510 in a clockwise or counterclockwise direction through magnetic force created between the driving coil 530 and the driving magnet 540. The driver 503 may rotate the first substrate member 510 such that the optical axis CS of the image sensor 200 may selectively coincide with the optical axes C1, C2, C3, and C4 of the first lens module 110 to the fourth lens module 140. As an example, the driver 503 may rotate the first substrate member 510 in a clockwise direction by 90 degrees in the state illustrated in FIG. 12 such that the optical axis CS of the image sensor 200 may match the optical axis C4 of the fourth lens module 140. As another example, the driver 503 may rotate the first substrate member 510 in a clockwise direction by 180 degrees in the state illustrated in FIG. 12 such that the optical axis CS of the image sensor 200 may match the optical axis C2 of the second lens module 120.

The camera module 14, according to the example embodiment, may further include a means for sensing the position of the image sensor 200. For example, the camera module 14 may further include a sensing device 600. The sensing device 600 may include a sensing coil 610 and a sensing magnet 620. The sensing coil 610 may be disposed on the first substrate member 510, and the sensing magnet 620 may be disposed on the second substrate member 520. The sensing magnet 620 may be disposed in a position corresponding to the optical axes C1, C2, C3, and C4 of the first lens module 110 to the fourth lens module 140. For example, the plurality of sensing magnets 620 may be disposed with an equal distance from the first lens module 110 to the fourth lens module 140 about the fixed shaft FS.

The sensing device 600 may sense the position of the image sensor 200 through interaction between the sensing coil 610 and the sensing magnet 620. For example, the sensing device 600 may calculate a rotation angle of the first substrate member 510 and the position of the image sensor 200 based on a magnitude of the magnetic field received through the sensing coil 610. Therefore, the camera module 14, according to the example embodiment, may, by calculating the driving magnitude of the driver 503 through the rotation angle of the first substrate member 510 and the position information of the image sensor 200 obtained by the sensing device 600, allow the optical axis CS of the image sensor 200 to coincide with the first optical axis C1 to the fourth optical axis C4.

The driver 503, according to the example embodiment, may enable upward movement of the first substrate member 510. For example, the driver 503 may enable vertical movement of the first substrate member 510 by supplying a current to the driving coil 530 such that magnetic forces of the same direction and magnitude may be created between the plurality of coils 532, 534, 536, and 538 and the plurality of magnets 542, 544, 546, and 548.

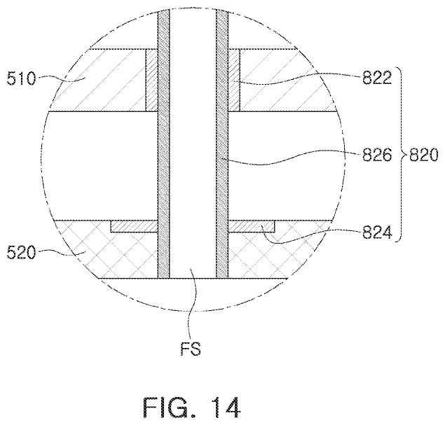

The camera module 14, according to the example embodiment, may further include a component for electrical connection between the first substrate member 510 and the second substrate member 520. For example, the camera module 14, according to the example embodiment, may include a connection terminal 820, as illustrated in FIG. 14. The connection terminals 820 (822, 824, and 826) may be integrated with the first substrate member 510, the second substrate member 520, and the fixed shaft FS by a molded interconnected device (MID) method. For example, the first connection terminal 822 may be integrated with the first substrate member 510, the second connection terminal 824 may be integrated with the second substrate member 520, and the third connection terminal 826 may be integrated with the fixed shaft FS. However, the method of forming the connection terminals 820 (822, 824, and 826) is not limited to the MID method.

The camera module 14 configured as above may be easily mounted in a small electronic device as the plurality of lens modules 110, 120, and 130, and 140 may be disposed in a limited space. Also, since the camera module 14, according to the example embodiment, enables various types of imaging through the image sensor 200, manufacturing costs of the camera module may be reduced.

According to the aforementioned example embodiments, various fields of view and various types of imaging may be performed.

Also, since the camera module in an example embodiment uses a single image sensor, the internal structure of the camera module may be simplified.

An example embodiment of the present disclosure is a camera module configured to enable various types of imaging.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a first lens module and a second lens module, disposed in a first direction intersecting an optical axis direction;
an image sensor configured to convert an optical signal incident through the first lens module and the second lens module into an electrical signal; and
a driver configured to move the image sensor in the first direction.

2. The camera module of claim 1,
wherein the first lens module is configured to include a wide-angle optical imaging system, and
wherein the second lens module is configured to include a telephoto optical imaging system.

3. The camera module of claim 1,
wherein the driver includes:
a first substrate member coupled to the image sensor and including a driving coil disposed in the first direction;
a second substrate member, including a driving magnet disposed in the first direction; and
a guide member disposed on the second substrate member and having a groove into which a portion of the first substrate member is insertable.

4. The camera module of claim 3, further comprising:
a sensing device configured to sense a position of the image sensor.

5. The camera module of claim 4, wherein the sensing device includes a sensing coil and a sensing magnet formed on the first substrate member and the second substrate member, respectively.

6. The camera module of claim 1, further comprising:
a third lens module disposed in the first direction.

7. The camera module of claim 6, wherein the third lens module has optical properties different from optical properties of the first lens module and the second lens module.

8. The camera module of claim 1, further comprising:
a lifter configured to move the image sensor in the optical axis direction.

9. The camera module of claim 8, wherein the lifter includes a pin member configured to push the image sensor in the optical axis direction.

10. The camera module of claim 8, wherein the lifter includes a driving magnet and a driving coil, and
the driving magnet and the driving coil is configured to apply attractive force and repulsive force to the image sensor.

11. The camera module of claim 1, wherein the driver is further configured to selectively move the image sensor in the first direction to align with the first lens module or the second lens module.

12. The camera module of claim 1, wherein the optical signal incident through the first lens module is different from the optical signal incident through the second lens module.

13. A camera module, comprising:
a first lens module, a second lens module, and a third lens module, disposed around a virtual axis;
a first substrate member, including an image sensor configured to convert optical signals emitted from the first lens module to the third lens module into electrical signals, the first substrate member configured to rotate about a fixed shaft; and
a driver configured to rotate the first substrate member about the fixed shaft such that an optical axis of the image sensor selectively coincides with an optical axis of the first lens module, the second lens module, or the third lens module.

14. The camera module of claim 13, wherein the first lens module to the third lens module are configured to have different optical properties.

15. The camera module of claim 13, wherein the driver includes a driving magnet and a driving coil formed on the first substrate member and the second substrate member disposed to oppose the first substrate member, respectively.

16. The camera module of claim 13, further comprising:
a sensing device configured to sense a position of the image sensor.

17. The camera module of claim 13, further comprising:
a connection terminal configured to connect the first substrate member to the second substrate member.

18. A camera module, comprising:
a plurality of lens modules;
an image sensor configured to convert an optical signal incident through each of the lens modules into an electrical signal, and move in an optical axis direction; and
a driver configured to linearly drive the image sensor along a groove in a first direction intersecting the optical axis direction of the image sensor.

19. The camera module of claim 18, wherein the image sensor is configured to move in the optical axis direction using a driving magnet and a driving coil.
